(19) United States
(12) Patent Application Publication
(10) Pub. No.: US 2025/0047215 A1
(43) Pub. Date: Feb. 6, 2025

(54) High Efficient Motor Drive

(71) Applicant: Revolution Electric Motor Company, Inc., Reno, NV (US)

(72) Inventors: Christopher W. Gabrys, Reno, NV (US); Timothy S. Rodgers, Bainbridge Island, WA (US)

(21) Appl. No.: 18/790,014

(22) Filed: Jul. 31, 2024

Related U.S. Application Data
(60) Provisional application No. 63/530,336, filed on Aug. 2, 2023.

(51) Int. Cl. H02M 7/537; H02M 1/00

(52) U.S. Cl. CPC H02M 7/537; H02M 1/0048

(57) ABSTRACT

An electronic motor drive for driving a synchronous motor comprising a hard switched non-modulating output inverter that is switched to commutate power to motor phase windings of a connected synchronous motor, and a soft switched power converter that converts supply power into regulated current supplied to the output inverter through a variable link connection. The power converter utilizes a main switch to regulate power to through current mode control, and an extra added auxiliary switch that connects a shunt resonant network in parallel across the main switch that when activated that provides controlled resonance only during switching transitions of the main switch. Switching of the main switch on and off at near zero voltage reduces the switching losses. The output inverter provides six-step commutation of power to the phase windings while regulation by the main switch is provided through pulse width modulation.

This invention pertains to electronic motor drives for powering synchronous motors, and more particularly to a motor drive that significantly reduces losses in the conversion of supply power to synchronous power for driving a motor, by the use of a novel topology and functioning. Through the reduction of power loss and resulting heat generation, along with dramatically lower semiconductor switching stresses and EMI generation, the new drives further simultaneously provide for longer life and more reliable operation. The drives additionally improve the reliability of powered synchronous motors by reduced dV/dt and while precluding generation of significant common mode voltages and motor bearing currents. The motor drive topology employs a unique combination of elements that work together to enable it to minimize the sources of loss in the drive, particularly including semiconductor switching and conduction losses in each of the different sections of the motor drive.

### BACKGROUND OF THE INVENTION

There is much effort presently being undertaken to develop new electric motors and generators that can provide higher efficiency power conversion between electrical and rotary mechanical energy. Simultaneously, efforts are also focused on reducing the amount of materials utilized and reducing manufacturing costs, while attaining higher efficiency. New electric machines that can achieve higher power conversion efficiency, but are more costly than current traditional machines, are less likely to be well-accepted into the marketplace if at all. The industry-wide goal is to provide higher efficiency and also have lower costs.

Development of new electric motors for achieving higher efficiency is mostly focused on use of synchronous topologies, which require the use of a variable frequency inverter to operate. Use of electronic inverters or motor drives is also becoming commonplace as a means to increase operational efficiency with all motors by varying the rotational speed, which supports the emergence of new synchronous motors. As the performance of synchronous motors is increased, the inherent inductance of the motor windings typically decreases. This reduced motor inductance results in a desire for higher electronic motor drive switching frequencies to prevent motor losses from harmonic switching ripple currents of the motor drive reflected into the motor. Unfortunately, higher switching frequencies cause higher motor drive switching losses in the output inverter section along with undesirable high EMI generation.

Accordingly, a new motor drive with a unique topology is needed that can preclude generation of high motor drive losses and EMI while providing power regulation switching at higher frequencies. Such a motor drive should also be able to operate reliably with long operating life by minimizing the stress on the all semiconductor devices utilized. A new motor drive should also be cost-optimized to reduce the necessary amount of use of costly wide band gap transistor switches for high frequency switching.

### SUMMARY OF THE INVENTION

The invention provides an electronic motor drive that is uniquely able to provide commutation and high frequency power regulation switching without producing of high drive losses. The motor drive accomplishes high efficiency operation at high frequency, along with low device stresses and EMI generation through the topology and functioning of its different drive sections. It is further able to do this with minimized costs by having only a minimum number of wide band gap transistor switches utilized. The invention provides an electronic motor drive for driving a synchronous motor comprising a hard switched, non-modulating output inverter that commutates power to motor phase windings of a connected synchronous motor, and a modulating power converter that is soft switched converting supply power into regulated current supplied to the output inverter through a variable link connection. The power converter utilizes a main switch that regulates power to the variable link connection and to the motor phase windings, and an auxiliary switch that is switched to cause the voltage across the main switch to approach zero for instances of switching of the main switch and enabling reduced switching losses in the main switch as the power converter regulates torque of the synchronous motor. Switching of the main switch on and off at zero voltage allows the the switching losses for current regulation to be made almost zero. Unlike conventional motor drives with combined current regulation switching and the commutation switching inside the output inverter and making zero voltage switching practically impossible, the new motor drive moves the current regulation switching to a separate power converter and also specially combines a converter topology with an additional extra switch specifically for enabling drive current regulation switching loss near elimination. This added high frequency auxiliary transistor switch adds additional costs to the drive, particularly when using a wide band gap type such as silicon carbide, but the substantial benefits of both zero voltage turn on and turn off switching of the main switch outweighs the added costs.

Likewise, it is contrary to teachings of those skilled in the art of electronic motor drive design to choose to employ hard switching for the inverter, having switching losses, with a power converter employing soft, zero voltage and near losses switching. This is an unusual combination. However, we have found that this unique combination is very beneficial and it provides for a highly reliable motor drive with reliable commutation and very high efficiency. One key to this outcome is in the difference in switching frequencies required in the different drive sections, upon the drive separating the required switching functions. The power converter current regulation switching must be very high frequency by necessity for low inductance synchronous motors and is therefore switched at zero or near zero voltage. The output inverter providing only commutation switching can operate up to 1000 times lower frequency and hence we have found can have acceptable low switching losses even with hard switching. Hard switching of the output inverter with switching losses, however enables the ability for simple and reliable six-step commutation which can be accomplished by measuring back emf zero crossings and not using complex high speed flux vector calculations. From this drive topology with combination of elements, the new motor drive achieves higher efficiency, a dramatic reduction in dV/dt and EMI generation, desirable constant frequency drive regulation switching operation at high frequency and all with minimized stress on all semiconductor devices in the drive.

The drive topology with separated regulation switching and zero voltage switching in the regulation in accordance with the invention further enables very large and high power drive MOSFETs to be utilized and switched at MHz frequencies. Accordingly, the drive topology and functioning makes it possible for the motor drive invention to be operated with very high frequency and to be uniquely scaled up to very large drive sizes at the same time. The new high frequency drives are no longer restricted for, or limited to only low power use as conventionally with other high frequency motor drives.

As is known in the art of motor drives, having an additional drive section would typically result in lower drive efficiency as more sections conventionally means more places for losses to occur. However, this is not the case with the new motor drive. The switching losses in the power converter are essentially eliminated, although additional conduction losses may be created but these can be greatly minimized. Unlike quasi resonant converters that can switch at zero voltage, the drive in accordance with the invention employs an added auxiliary switch that connects a shunt resonant network across the switch when activated. The resonant network causes the voltage across the main switch to temporarily go to zero when auxiliary switch is activated for near lossless switching of the main switch regulating the current to the output inverter. As a result of the drive topology, the stresses on all semiconductor devices in the drive are minimized, the operation range is able to be made to be very wide (unlike other methods of zero voltage or current switching means) and synergistically accommodates the requirements of motor speed control.

In an additional embodiment, the output inverter provides six-step commutation of the power to the phase windings while regulation by the main switch is provided through pulse width modulation. In high frequency motor and drive applications, electronic drives commonly create common mode voltages on the motor shaft as generated by unbalanced phase excitation. The higher the regulation switching frequency, the greater the problem which causes bearing currents and motor failures. As known to those skilled in the art, motor drive switching at high frequencies greater than 100 kHz can cause serious motor bearing reliability issues. However, we have found that the unique topology of the new drive substantially eliminates generation of these shaft voltages and resulting bearing failures and without requiring shaft grounding brushes and their maintenance, and can operate at up to 1 MHz and higher. The motor drive in accordance with the invention can employ six-step commutation whereby only two of the three motor phases are excited at any only time and are electrically in series with a common regulation, causing their voltages balance each other out. This is opposed to switching regulation conducted in output inverters exciting three phases at a time, as is conventionally done. The sum of two leg voltages connected in electrically in series and with common regulation in accordance with the invention is zero, unlike the instantaneous sum of three wye connected and separately regulation-switched legs in common drives. We have surprisingly found that this precludes significant generation of common mode or shaft voltages and bearing currents, regardless of regulation switching frequency. This substantial benefit is particularly beneficial for reliability applications such as electric aviation and may outweigh all other additional benefits provided for such applications.

In a further embodiment, the auxiliary switch connects a resonant network in parallel to the main switch when activated providing controlled resonance only during switching transitions of the main switch. Although zero voltage switching may be accomplished by several means such zero voltage switching pulse width modulation (ZVS PWM) or non-resonant ZVT, the use of resonant network ZVT is preferable. ZVS PWM connects a shunt in parallel across an inductor in the power path causing high voltage stress on the main switch. Particularly, the main switch in a single-ended ZVS PWM suffers from high voltage stress that is proportional to the load range which ZVS is maintained, and a wide load range is needed for operation in the electronic motor drive. In non-resonant ZVT, there is typically no capacitor in series with the auxiliary circuit inductor. On the contrary, resonant network ZVT recycles the energy from the voltage across the main power switch for higher efficiency. The auxiliary switch functioning allows the converters to achieve soft switching without increasing the voltage and current stresses of the main switch or diode. It should be defined herein that zero voltage switching of the main switch in the power converter means that it need not be exactly zero but means approaching zero voltage such as less than 5% full operating voltage or more preferably less than 1%, and most preferably closest to zero as practically achievable. The lower the lower the voltage across the main switch when transition, the lower the switching losses, lower EMI, lower dV/dt and the more preferable.

In an additional embodiment, the power converter operates as a buck converter providing zero voltage transition switching for the regulation of current to the output inverter, while the switches of the output inverter commutating the phase windings are switched at non-zero voltages. The zero voltage transition switching is enabled in the buck converter providing the current regulation by the use of the auxiliary switch and resonant shunt network. The clamped resonant energy moves energy in the from of voltage across the main switch temporarily for the switching instances of the main switch to become near lossless and moves this energy into the components of the resonant network. After switching of the main switch and subsequent switching off of the auxiliary switch, the energy of the clamped resonant network is recycled to the main switch regulation circuit. Commutation is conducted in the inverter and it cannot practically be conducted at zero voltages. However the commutation at non-zero voltage is conducted at the much lower synchronous frequency for the motor (which depends only on the motor operating speed and number of poles). Hence, commutation and total drive operation are both low loss, because of separation from the regulation switching in the motor drive sections.

In yet further embodiments, the power converter supplies the output inverter operating in current mode control. Current control mode operation of the buck converter uses the current supplied to the variable link and to the input of the output inverter to be monitored and used for feedback controlling the PWM duty cycle of the main switch. This controls the torque of the synchronous motor directly instead of switching in the output inverter.

Different designs of the buck converter can be utilized to provide zero voltage transition switching regulation. In some designs, only the main switch is transitioned at zero voltage, while the auxiliary switch handing much lower power is hard switched. This is not the most desirable, because of some switching loss generated in the auxiliary switch. In an additional embodiment, the power converter is designed to minimize its switching loss by using a topology in which the the auxiliary switch is switched at instances of near zero current. The power converter comprises both a main switch that is switched to regulate power to the variable link connection and the motor phase windings through current mode control, and an auxiliary switch that is switched on just prior to switching of the main switch and is switched off just after switching of the main switch. Both the main switch and auxiliary switch are cach switched in close timing together in providing power regulation, though the main switch directly controls the amount of power to the variable link connection and motor phase windings while the auxiliary switch reduces the switching loss and EMI generation from the main switch. The output inverter preferably provides no regulation and commutates the phase windings in steps.

Because the motor drive in accordance with the invention is controlling the torque directly instead of the controlling frequency of the power to the synchronous motor directly, motor drive speed control is accomplished differently. In a further embodiment, the motor drive causes the duty cycle of the main switch to be increased with increasing rotational speed of the motor until reaching the operating set point speed of the speed control loop of the motor drive, at which point the motor drive causes the duty cycle of the main switch to be reduced. In this way, speed of the driven synchronous motor is approximately set simply by monitoring the speed and then it commanding reduced the motor torque when near the desired set speed. The power converter operates as a buck converter having zero voltage transition switching for the regulation of power, while the switches of the output inverter are switched at non-zero voltages. In typical industrial motor applications, AC utility power at relatively high voltage is rectified to a relatively high DC voltage for powering the drive inverter. In the new drive, the buck converter reduces this voltage through power regulation which limits the current to the output inverter and also indirectly controls motor speed. Zero voltage transition switching is enabled through the auxiliary switch temporarily enabling switching at zero voltage on the main switch. The rotational speed of the connected synchronous motor is controlled by regulation of the current supplied to the output inverter through switching of both the main switch and the auxiliary switch. Unlike conventional drives which control speed through the commutation in the inverter, speed is controlled by the power regulation prior to the output inverter conducted at zero voltage switching with each current regulation switching transition requiring the switching of both the auxiliary switch and the main switch.

In additional embodiments, the invention provides an electronic motor drive for driving a synchronous motor comprising a hard switched output inverter that commutates power to motor phase windings of a connected synchronous motor, and a soft switched power converter that converts supply power into regulated current that drives the output inverter through a variable link connection. The power converter comprises both a main switch that regulates power to the variable link connection and to the motor phase windings, and an auxiliary switch that clamps a resonant network in parallel across the main switch when activated, causing the voltage across the main switch to approach zero at instances of switching both on and off of the main switch enabling reduced switching losses in the main switch as the power converter regulates torque of the synchronous motor. Additionally, the output inverter provides non-modulating six-step commutation switching of the power to the phase windings while the main switch providing regulation is switched at a constant frequency. The preferred regulation switching control of electronic motor drives in general is typically to utilize constant frequency for both the benefits of case and for simplicity of filtering. Other means of zero voltage switching, if alternatively accomplished through full resonance or quasi resonance for example, would necessarily operate at variable frequency. This would be undesirable. The new motor drive provides zero voltage near losses drive regulation switching at constant frequency like traditional pulse width modulation regulation. A key difference is that the auxiliary switch and shunt resonant network temporarily cause the voltage on the main switch to go to zero for instances of switching and revert back to fixed frequency pulse width modulation at all other times. In a further embodiment, the main switch is switched at constant frequency.

For resonant converters and quasi-resonant converters, resonance is utilized all the time for switching. This would lead to limitations on the range of duty cycle and output to input voltage ranges for low loss power conversion switching. It also leads to excessive transistor and or diode device stresses which can limit operation and life and is not preferable. In a further embodiment of the invention, the auxiliary switch and the resonant network provide controlled resonance only during switching transitions of the main switch. The main switch regulation switching is at a constant frequency for use of desirable PWM switching control while resonance is only utilized for the main switch transition. Excessive device stresses and EMI can be eliminated. Further, this resonance can be created right across the main switch for lowest losses and widest operating range without additional drive device stresses. In this case, the auxiliary switch connects a shunt resonant network in parallel across the main switch that when activated that provides controlled resonance only during switching transitions of the main switch.

In yet additional embodiments, the invention provides an electronic motor drive for driving a synchronous motor with a hard switched, non-modulating output inverter that commutates power to motor phase windings of a connected synchronous motor, and a soft switched power converter that converts input power into regulated current supplied to the output inverter through a variable link connection. The power converter comprises both a main switch that is switched to regulate power to the variable link connection and the motor phase windings, and an auxiliary switch that is switched on prior to switching transitions of the main switch and is switched off after switching transitions of the main switch enabling reduced switching losses in the main switch as the power converter regulates torque of the synchronous motor. Further, the output inverter can provide stepped commutation of the phase windings while the regulation by the main switch is controlled through pulse width modulation.

### DESCRIPTION OF THE DRAWINGS

The invention and its many advantages and features will become better understood upon reading the following detailed description of the preferred embodiments in conjunction with the following drawings, wherein:

FIG. 1 is an isometric view of an air core motor for use with the motor drive in accordance with the invention.

FIG. 2 is a a schematic drawing of an electronic motor drive in accordance with the invention.

FIG. 3 is a plot of power converter current versus motor speed of a motor drive in accordance with the invention.

FIG. 4 is a plot of power converter main switch duty cycle versus motor speed of a motor drive in accordance with the invention.

FIG. 5 is a schematic drawing of an alternate configuration electronic motor drive in accordance with the invention.

### DESCRIPTION OF THE PREFERRED EMBODIMENT

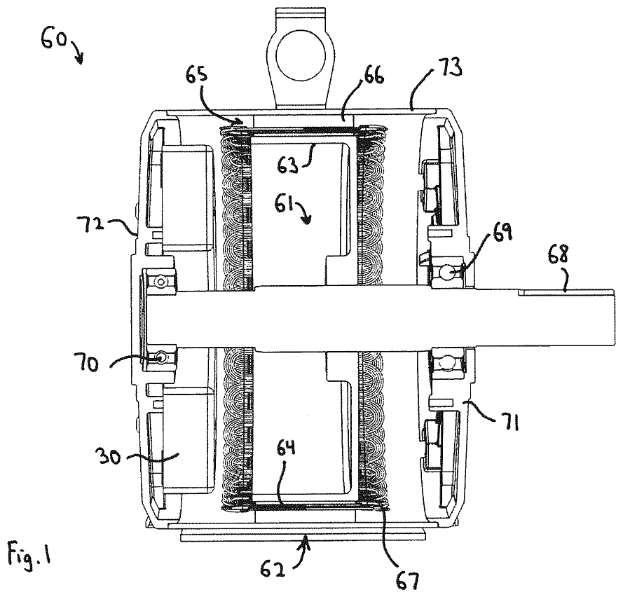

Turning to the drawings, wherein like reference characters designate identical or corresponding parts, an isometric view drawing of an air core motor for use with the motor drive in accordance with the invention is shown in FIG. 1. The air core motor 60 is comprised of a rotor 61 and a stator 62. The rotor 61 has a rotor backiron 63 with an attached array of alternating polarity permanent magnets 64. The magnets 64 drive magnetic flux back and forth across a magnetic air gap 65 to a laminated stator backiron 66. Litz wire winding 67 are located within the magnetic airgap 65 and are bonded to the stator backiron 66. The rotor 61 is attached to a center shaft 68 that is journaled for rotation by bearings 69, 70. The bearings 69, 70 are supported by housing endplates 71, 72 that are connected by outer housing tube 73. The stator backiron 66 is supported by the outer housing tube 73. The windings 67 are energized by the motor drive 30 which is preferably contained inside the housing tube 73 and mounted to housing end plate 72. Although an air core motor is shown, the motor drive in accordance with the invention may also be used to drive other types of synchronous motors including more conventional and slot wound types, but with expected lower motor performance.

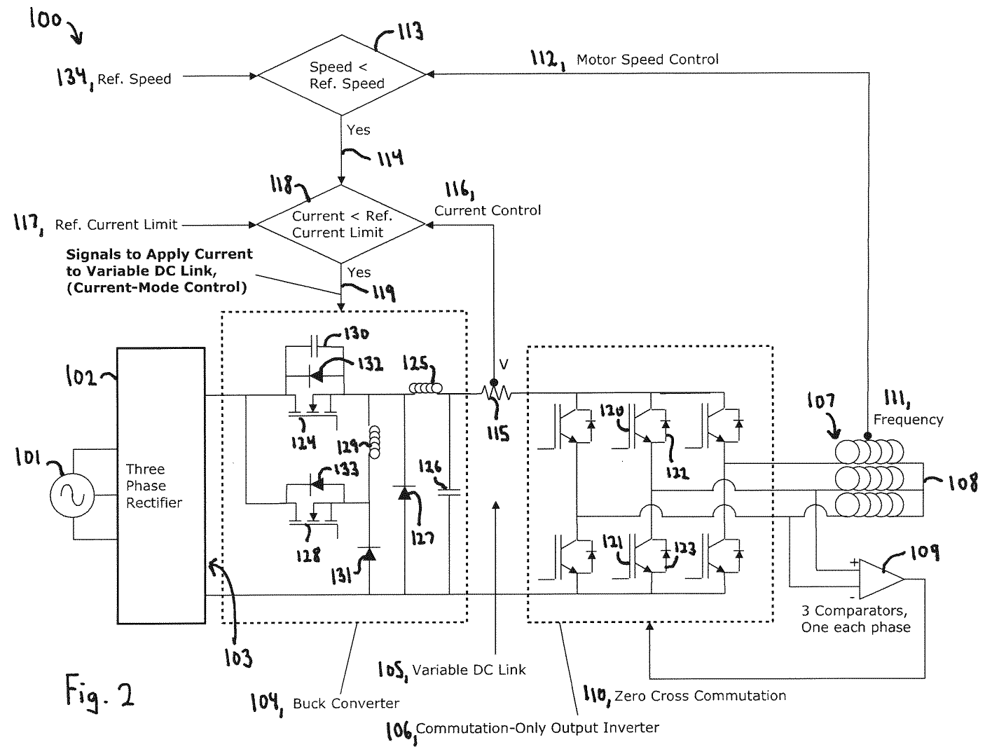

An electronic motor drive in accordance with the invention is shown in FIG. 2. The motor drive 100 receives AC supply power 101 into a rectifier 102 that converts the AC supply to DC supply power 103. The buck converter 104 regulates the current a variable DC link connection 105 that supplies the commutation-only output inverter 106. The output inverter 106 provides 120 degree commutation switching to the phase windings 107 while current regulation is provided by the buck converter 104 operation in current mode control. The three phase windings 107 are connected together with wye connection 108 and three comparators 109 sense the back emf zero crossing of the instantaneously unenergized phase winding to trigger zero cross commutation 110. The output inverter 106 comprises six IGBTs 120, 121 and freewheeling diodes 122, 123 that provide six-step commutation with low frequency synchronous unmodulated switching. Frequency measurement 111 provides motor speed control feedback 112 for speed control logic 113 comparing to a reference speed signal 134. When the speed control feedback signal 112 is less than the reference speed signal 134, a command 114 is given to provide acceleration current. A current sense resistor 115 provides current control feed back on the variable DC link connection 105 to a current control logic 118 that compares with a reference current limit 117, that signals to apply current in current control mode 119. A key to achieving high motor drive efficiency is in reducing the losses in the difference sections of the motor drive 100. The input rectifier 102 has minimized losses though use of high efficiency low forward voltage drop diodes. The output inverter 106 also has minimized losses through use of low conduction loss IGBTs 102, 121 and by switching only at low frequency to provide commutation without providing regulation switching. The high frequency current regulation switching is conducted through the zero voltage switching, which is specifically enabled by the topology to provide for simultaneous near zero switching loss and EMI generation, low semiconductor stresses with the very wide output to input range that is required for motor drive operation. The buck converter 104comprises a SiC MOSFET main switch 124 and filter inductor 125, filter capacitor 126 and diode 127. The diode 127 could alternately be replaced with a MOSFET switch to change the buck converter from asynchronous to synchronous, which would reduce conduction loss and increase efficiency with additional costs. Zero voltage switching is enabled in the main switch 124 at constant frequency modulation through the addition of auxiliary switch 128 that clamps resonant network of resonant inductor 129, resonant capacitor 130 and diode 131 to the main switch 124 when turned on. Anti-parallel diodes 132, 133 provide protection for the main and auxiliary MOSFET switches 124, 128. In operation, the buck converter 104 behaves like a constant frequency pulse width modulation buck converter, except the auxiliary switch 128 is switched on just before switching the main switch 124 on or off, such that the voltage across the main switch 124 is brought to zero for losses switching. The auxiliary switch 128 is then switched off just after the switching of the main switch 124 on or off.

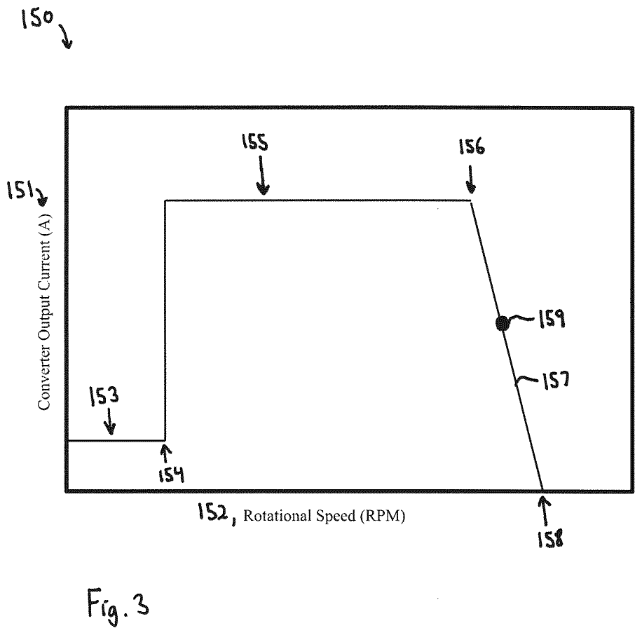

A plot of power converter current versus motor speed of a motor drive in accordance with the invention is shown in FIG. 3. The plot 150 shows the converter output current 151 to the variable versus motor rotational speed 152. The plot is shown for a position-sensorless configuration where the commutation is triggered through monitoring of back emf of the motor phase windings. The motor initially starts and accelerates in open loop commutation with potentially reduced current 153, until it reaches the transition speed 154 where back emf is sufficient to allow sensorless operation. Alternatively if position sensors are utilized, the motor could more easily be started at full current and torque. After the transition speed 154, the motor is accelerated in closed commutation at full current 155 until reaching the set operating speed 156. Above the set operating speed 156, the buck converter linearly reduces the current to zero at the zero current speed 158. The actual operating speed 159 will end up being somewhere along the slope 157 between set operating speed and zero current speed as the drive output current and torque balances with the actual load torque.

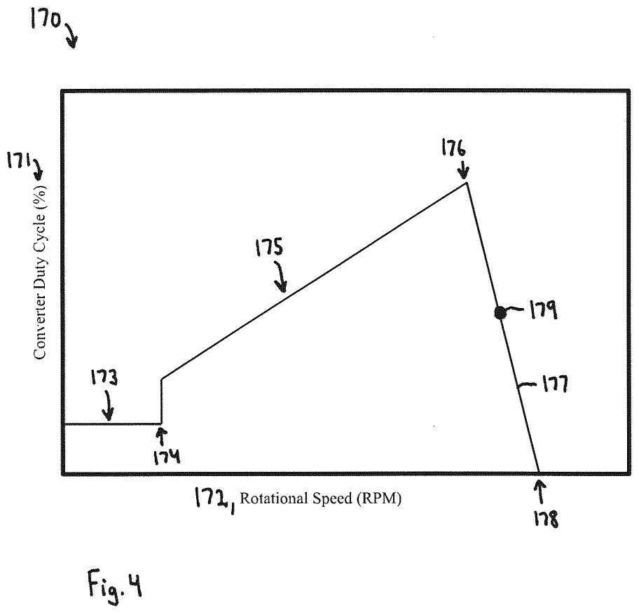

A plot of power converter main switch duty cycle versus motor speed of a motor drive in accordance with the invention is shown in FIG. 4. The plot 170 shows the buck converter pulse width modulation duty cycle 171 of the main switch versus motor rotational speed 172. The plot is shown for a position-sensorless configuration where the commutation is triggered through monitoring of back emf of the motor phase windings. The motor initially starts and accelerates in open loop commutation with low duty cycle 173, until it reaches the transition speed 174 where back emf is sufficient to allow sensorless operation. After the transition speed 174, the motor is accelerated in closed commutation at at higher duty cycle. The duty cycle ramp 175 increases with motor speed 172 until reaching the set operating speed set point 176. Above the set operating set point speed 176 of the speed control loop, the buck converter reduces the duty cycle towards zero at the zero duty cycle speed 178. The actual operating speed 179 will end up being somewhere along the slope 177 between set operating speed and zero duty cycle speed as the drive output current and torque balances with the actual load torque.

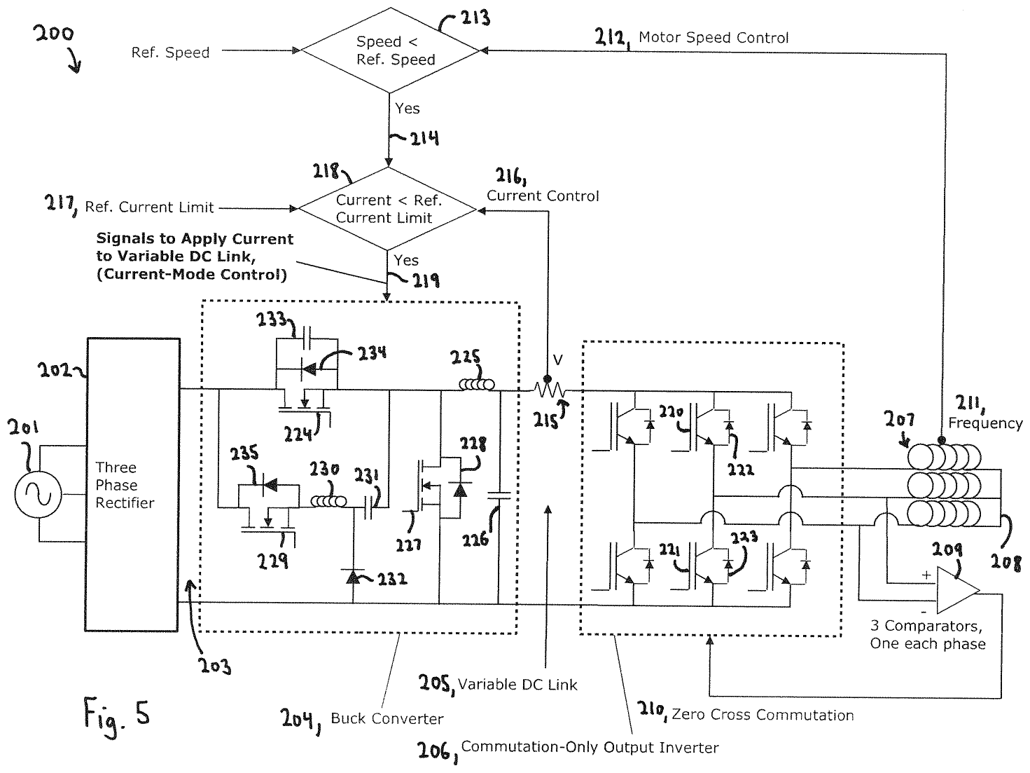

An alternate configuration electronic motor drive in accordance with the invention is shown in FIG. 5. The motor drive 200 receives AC supply power 201 into a rectifier 202 that converts the AC supply to DC supply power 203. The buck converter 204 regulates the current a variable DC link connection 205 that supplies the commutation-only output inverter 206. The output inverter 206 provides 120 degree stepped commutation switching to the phase windings 207 while current regulation is provided by the buck converter 204 operation in current mode control. The three phase windings 207 are connected together with wye connection 208 and three comparators 209 sense the back emf zero crossing of the instantaneously unenergized phase winding to trigger zero cross commutation 210. The output inverter 206 comprises six IGBTs 220, 221 and freewheeling diodes 222, 223 that provide hard switched, six-step commutation with low frequency synchronous unmodulated switching. IGBT's 220, 221 are switched at non-zero voltages and hence incur switching losses. Frequency measurement 211 provides motor speed control feedback 212 for speed control logic 213 comparing to a reference speed signal 234. When the speed control feedback signal 212 is less than the reference speed signal 234, a command 214 is given to provide acceleration current. A current sense resistor 215 provides current control feed back on the variable DC link connection 205 to a current control logic 218 that compares with a reference current limit 217, that signals to apply current in current control mode 219. The high frequency current regulation switching is conducted through the zero voltage transition switching, which is specifically enabled by the topology to provide for simultaneous near zero switching loss and EMI generation, low semiconductor stresses and with the very wide output to input range that is required for motor drive operation. The buck converter 204 comprises a SiC MOSFET main switch 224 and filter inductor 225, filter capacitor 226 and synchronous rectification switch 227 with anti-parallel diode 228, providing for synchronous operation. Zero voltage transition switching is enabled in the main switch 224 at constant frequency pulse width modulation and through the activation of auxiliary switch 229 that connects resonant network of resonant inductor 230, resonant capacitor 231 in parallel across the main switch 224 during instances of switching. Anti-parallel diodes 234 235 provide protection for the main and auxiliary MOSFET switches 224, 229 with switch capacitance 233. High frequency Schottky diode 232 discharges the resonant capacitor before turn on of synchronous switch 227. In operation, the buck converter 204 behaves like a constant frequency pulse width modulation buck converter, except the auxiliary switch 228 is switched on just before switching the main switch 224 on or off, such that the voltage across the main switch 224 is brought to approach zero for near losses switching. The auxiliary switch 229 is then switched off just after the switching transition of the main switch 224. The resonant network 230, 231 provides controlled resonance only during switching transitions of the main switch 224. Unlike the motor drive shown in FIG. 2, both the main switch 224 and auxiliary switch 229 both achieve soft switching. The auxiliary switch 229 is switched in this configuration both on and off at zero or near zero current for near zero switching losses.

Other circuit designs that provide for zero voltage switching of the main switch of the power converter feeding the output inverter of the motor drive could alternatively be used as long as they employ an auxiliary switch that is activatable to bring the voltage across the main switch to zero for switching with reduced losses. Such circuit designs would preferably reduce switching losses and EMI generation, have low semiconductor stresses and operate over wide output to input range for motor drive operation. Obviously, numerous modifications and variations of the described preferred embodiment are possible and will occur to those skilled in the art in light of this disclosure of the invention. Accordingly, I intend that these modifications and variations, and the equivalents thereof, be included within the spirit and scope of the invention as defined in the following claims.

What is claimed is:

1. An electronic motor drive for driving a synchronous motor comprising:
a hard switched, non-modulating output inverter that commutates power to motor phase windings of a connected synchronous motor, and a modulating power converter that is soft switched converting supply power into regulated current supplied to said output inverter through a variable link connection;
said power converter utilizes a main switch that regulates power to said variable link connection and to said motor phase windings, and an auxiliary switch that is switched to cause the voltage across said main switch to approach zero for instances of switching of said main switch and enabling reduced switching losses in said main switch as said power converter regulates torque of said synchronous motor.

2. An electronic motor drive as described in claim 1 wherein:
said output inverter provides six-step commutation of said power to said phase windings while regulation by said main switch is provided through pulse width modulation.

3. An electronic motor drive as described in claim 1 wherein:
said auxiliary switch connects a resonant network in parallel to said main switch when activated providing controlled resonance only during switching transitions of said main switch.

4. An electronic motor drive as described in claim 1 wherein:
said power converter operates as a buck converter providing zero voltage transition switching for said regulation of current to said output inverter, while the switches of said output inverter commutating said phase windings are switched at non-zero voltages.

5. An electronic motor drive as described in claim 1 wherein:
said power converter supplies said output inverter operating in current mode control.

6. An electronic motor drive as described in claim 1 wherein:
said auxiliary switch is switched at instances of near zero current.

7. An electronic motor drive as described in claim 1 wherein:
said motor drive causes the duty cycle of said main switch to be increased with increasing rotational speed of said motor until reaching the operating set point speed of the speed control loop of said motor drive, at which point said motor drive causes the duty cycle of said main switch to be reduced.

8. An electronic motor drive for driving a synchronous motor comprising:
a hard switched output inverter that commutates power to motor phase windings of a connected synchronous motor, and a soft switched power converter that converts supply power into regulated current that drives said output inverter through a variable link connection;
said power converter comprises both a main switch that regulates power to said variable link connection and to said motor phase windings, and an auxiliary switch that clamps a resonant network in parallel across said main switch when activated, causing the voltage across said main switch to approach zero at instances of switching both on and off of said main switch enabling reduced switching losses in said main switch as said power converter regulates torque of said synchronous motor.

9. An electronic motor drive as described in claim 8 wherein:
said output inverter provides non-modulating six-step commutation switching of said power to said phase windings while said main switch providing regulation is switched at a constant frequency.

10. An electronic motor drive as described in claim 8 wherein:
said auxiliary switch and said resonant network provide controlled resonance only during switching transitions of said main switch.

11. An electronic motor drive as described in claim 8 wherein:
said power converter operates as a buck converter providing zero voltage transition switching for said regulation of power to said output inverter, while the switches of said output inverter commutating said phase windings are switched at non-zero voltages.

12. An electronic motor drive as described in claim 8 wherein:
said power converter drives said output inverter operating in current mode control.

13. An electronic motor drive as described in claim 8 wherein:
said auxiliary switch is switched at instances of near zero current.

14. An electronic motor drive as described in claim 8 wherein:
said motor drive causes the duty cycle of said main switch to be increased with increasing rotational speed of said motor until reaching the operating set point speed of the speed control loop of said motor drive, at which point said motor drive causes the duty cycle of said main switch to be reduced.

15. An electronic motor drive for driving a synchronous motor comprising:
a hard switched, non-modulating output inverter that commutates power to motor phase windings of a connected synchronous motor, and a soft switched power converter that converts input power into regulated current supplied to said output inverter through a variable link connection;
said power converter comprises both a main switch that is switched to regulate power to said variable link connection and said motor phase windings, and an auxiliary switch that is switched on prior to switching transitions of said main switch and is switched off after switching transitions of said main switch enabling reduced switching losses in said main switch as said power converter regulates torque of said synchronous motor.

16. An electronic motor drive as described in claim 15 wherein:
said output inverter provides stepped commutation of said phase windings while said regulation by said main switch is controlled through pulse width modulation.

17. An electronic motor drive as described in claim 15 wherein:
said auxiliary switch connects a shunt resonant network in parallel across said main switch that when activated that provides controlled resonance only during switching transitions of said main switch.

18. An electronic motor drive as described in claim 15 wherein:
said power converter operates as a buck converter providing near zero voltage switching for said regulation of power to said output inverter, while the switches of said output inverter commutating said phase windings are switched at non-zero voltages.

19. An electronic motor drive as described in claim 18 wherein:
said power converter supplies said output inverter operating in current mode control.

20. An electronic motor drive as described in claim 15 wherein:
said auxiliary switch is switched at instances of near zero current.
